(19) United States
(12) Patent Application Publication
(10) Pub. No.: US 2024/0155369 A1
(43) Pub. Date: May 9, 2024

(54) COMMUNICATION DESIGN SUPPORT APPARATUS, COMMUNICATION DESIGN SUPPORT METHOD AND PROGRAM

(71) Applicant: NIPPON TELEGRAPH AND TELEPHONE CORPORATION, Tokyo (JP)

(72) Inventors: Minoru INOMATA, Tokyo (JP); Wataru YAMADA, Tokyo (JP); Nobuaki KUNO, Tokyo (JP); Motoharu SASAKI, Tokyo (JP)

(73) Assignee: NIPPON TELEGRAPH AND TELEPHONE CORPORATION, Tokyo (JP)

(21) Appl. No.: 18/284,271

(22) PCT Filed: Apr. 5, 2021
(86) PCT No.: PCT/JP2021/014540

§ 371 Date: Sep. 26, 2023

(51) Int. Cl. H04W 16/22; H04B 17/391; H04W 16/20

(52) U.S. Cl. CPC H04W 16/22; H04B 17/391; H04W 16/20

(57) ABSTRACT

A communication design support apparatus includes: a propagation model storage unit configured to store a propagation model; a site survey unit configured to collect data obtained by measuring a structure; a data processing unit configured to update a parameter of the propagation model; and a radio field intensity estimation unit configured to estimate a radio field intensity in the structure by applying the propagation model having the parameter having been updated.

### TECHNICAL FIELD

The present invention relates to a technology for supporting design of wireless communication according to the user's purpose of use.

### BACKGROUND ART

As the importance of digital social innovation has increased in recent years, for example, traffic on smartphones and the like has increased, and various things have been connected with the development of Internet of Things (IoT). Thus, the role of wireless communication has been remarkably expanded in various situations of life. Meanwhile, various wireless communication standards have appeared for diversified applications of wireless communication, and wireless frequency bands used therefor have been expanded to a high frequency band from several hundred MHz to several tens of GHz. Therefore, it has become necessary to properly use radio waves in frequency bands having different characteristics and various wireless communication standards according to the situation. In such a complicated heterogeneous wireless communication environment, it is ideal that the user can unconsciously and naturally use an appropriate wireless communication standard at any time.

### CONVENTIONAL ART LITERATURE

### Non-Patent Literature

Non-Patent Literature 1: Technology to Optimize Radio Access Networks: SON, July 2011

https://www.fujitsu.com/downloads/JP/archive/imgjp/jmag/vol62-4/paper15.pdf

### SUMMARY OF INVENTION

### Problem to be Solved by Invention

However, quality of wireless communication changes from moment to moment according to the situation, and the quality may be unstable due to an influence from a surrounding environment such as the user or a base station. Therefore, a technology for supporting design of wireless communication is required to use wireless communication with optimal quality according to the user's purpose.

An object of the disclosed technology is to support design of wireless communication according to the user's purpose of use.

### Means to Solve Problem

The disclosed technology is a communication design support apparatus including: a propagation model storage unit configured to store a propagation model; a site survey unit configured to collect data obtained by measuring a structure; a data processing unit configured to update a parameter of the propagation model; and a radio field intensity estimation unit configured to estimate a radio field intensity in the structure by applying the propagation model having the updated parameter that has been updated.

### Advantageous Effects of Invention

According to the disclosed technology, it is possible to support design of wireless communication according to the user's purpose of use.

### BRIEF DESCRIPTION OF DRAWINGS

FIG. 1 illustrates an overall configuration example of a communication design support system and a functional configuration example of a communication design support apparatus.

FIG. 2 is a flowchart showing an example of a flow of communication design support processing.

FIG. 3 is a flowchart showing an example of a flow of 3D CAD data generation processing.

FIG. 4 is a flowchart showing an example of a flow of ray tracing model tuning processing.

FIG. 5 is a flowchart showing an example of a flow of statistical model tuning processing.

FIG. 6 is a flowchart showing an example of a flow of environment label selection processing based on threshold determination.

FIG. 7 is a flowchart showing an example of a flow of classifier training processing.

FIG. 8 is a flowchart showing an example of a flow of environment label selection processing based on classifier determination.

FIG. 9 is a flowchart showing an example of a flow of frequency correction processing.

FIG. 10 illustrates a hardware configuration example of a computer.

FIG. 11 is a flowchart showing an example of a flow of communication design support processing according to a first example.

FIG. 12 is a flowchart showing an example of a flow of communication design support processing according to a second example.

FIG. 13 is a flowchart showing an example of a flow of communication design support processing according to a third example.

FIG. 14 is a flowchart showing an example of a flow of communication design support processing according to a fourth example.

FIG. 15 is a flowchart showing an example of a flow of communication design support processing according to a fifth example.

FIG. 16 is a flowchart showing an example of a flow of communication design support processing according to a sixth example.

### MODE FOR CARRYING OUT INVENTION

Hereinafter, an embodiment of the present invention (present embodiment) will be described with reference to the drawings. The embodiment described below is merely an example, and an embodiment to which the present invention is applied is not limited to the following embodiment.

A communication design support system 1 according to the present embodiment is a system that supports communication design work in various processes such as introduction, investigation, and proposal of a wireless communication system.

### (Overall Configuration Example of Communication Design Support System 1)

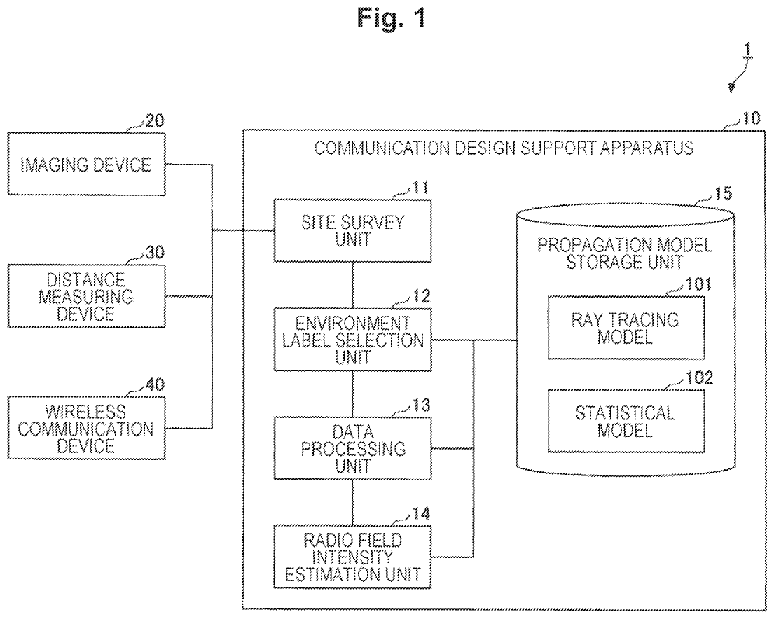

FIG. 1 illustrates an overall configuration example of a communication design support system and a functional configuration example of a communication design support apparatus. The communication design support system 1 includes a communication design support apparatus 10, an imaging device 20, a distance measuring device 30, and a wireless communication device 40.

The communication design support apparatus 10 includes a site survey unit 11, an environment label selection unit 12, a data processing unit 13, a radio field intensity estimation unit 14, and a propagation model storage unit 15.

The imaging device 20 is, for example, a camera, which images a communication use environment, acquires image data, and transmits the image data to the communication design support apparatus 10.

The distance measuring device 30 is, for example, a sensor or LiDAR, which measures a distance between an installed object and an inner wall or the like in the communication use environment, and transmits measurement data to the communication design support apparatus 10.

The wireless communication device 40 performs wireless communication in the communication use environment, acquires information indicating identification of wireless communication such as received power, and transmits the information to the communication design support apparatus 10.

### (Functional Configuration Example of Communication Design Support Apparatus 10)

The communication design support apparatus 10 includes the site survey unit 11, the environment label selection unit 12, the data processing unit 13, the radio field intensity estimation unit 14, and the propagation model storage unit 15.

The propagation model storage unit 15 stores a propagation model that defines processing of estimating a radio field intensity of wireless communication. The propagation model can be any of various models such as a ray tracing model 101 and a statistical model 102. The propagation model storage unit 15 may store either the ray tracing model 101 or the statistical model 102 or may store both for selecting one thereof to use.

The ray tracing model 101 is one kind of propagation model that estimates the radio field intensity by a method called a ray tracing method in which a radio wave is traced to simulate an image or the like that is observed at a certain point.

The statistical model 102 is one kind of propagation model that estimates the radio field intensity by statistical calculation based on a distance between transmission and reception, a field intensity, and the like.

The site survey unit 11 acquires various kinds of information from the imaging device 20, the distance measuring device 30, the wireless communication device 40, and the like and generates, for example, data indicating a structure of a building, an installed object, or the like in the communication use environment, for example, three dimensional computer aided design (3D CAD) data.

The environment label selection unit 12 selects an environment label to be given to the propagation model on the basis of, for example, the various kinds of information acquired from the imaging device 20, the distance measuring device 30, the wireless communication device 40, and the like and the data indicating the structure generated by the site survey unit 11. The environment label is data indicating classification of a characteristic of a communication environment.

The data processing unit 13 tunes the various propagation models stored in the propagation model storage unit 15 by applying a method such as machine learning.

The radio field intensity estimation unit 14 estimates the radio field intensity in the communication use environment to be designed by applying the various propagation models.

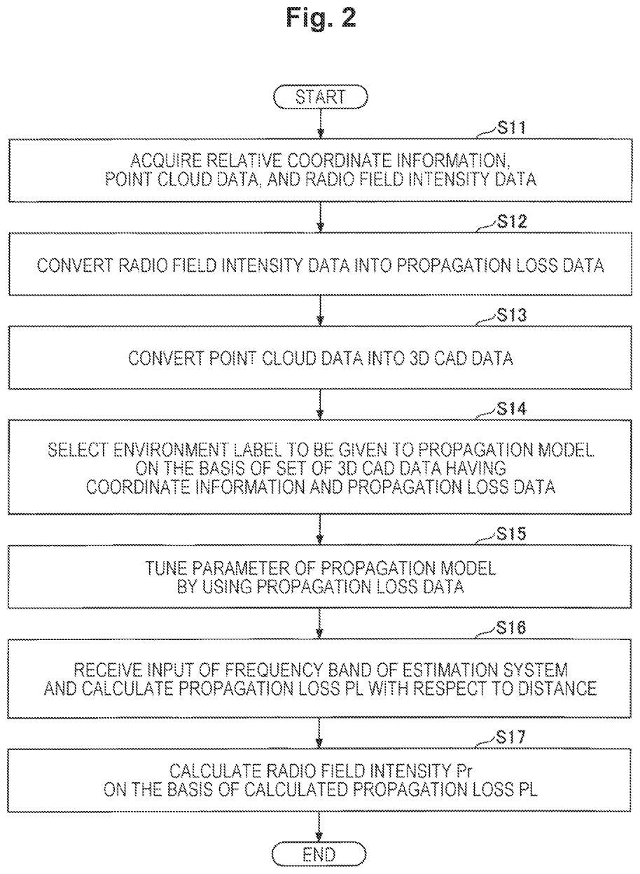

Next, a basic operation of the communication design support system 1 will be described with reference to the drawings. FIG. 2 is a flowchart showing an example of a flow of communication design support processing. Specific operations according to various use cases will be described later with reference to first to fourth examples.

The communication design support apparatus 10 starts communication design support processing in response to a user's operation, for example. The site survey unit 11 acquires relative coordinate information, point cloud data, and radio field intensity data on the basis of data received from each device (step S11). The relative coordinate information indicates a relative positional relationship among objects, facilities, and the like in the communication use environment. The point cloud data indicates three-dimensional coordinates of a large number of points showing positions and shapes of surfaces of the objects in the communication use environment. The radio field intensity data indicates an intensity of a radio wave at each point in the communication use environment.

For example, the site survey unit 11 applies a technology such as simultaneous localization and mapping (SLAM) to an image captured by the imaging device 20 or measurement data measured by the distance measuring device 30, thereby acquiring information indicating coordinates of objects, facilities, or the like to be designed as the relative coordinate information. The site survey unit 11 may simply receive the relative coordinate information to which the technology such as SLAM has been applied.

The site survey unit 11 analyzes the image captured by the imaging device 20, thereby acquiring point cloud data. The site survey unit 11 may simply receive the point cloud data as a result of image analysis.

The site survey unit 11 extracts the radio field intensity data from the measurement data received from the wireless communication device 40.

Next, the site survey unit 11 converts the radio field intensity data into propagation loss data (step S12). For example, the site survey unit 11 calculates propagation loss PL according to Expression (1) below.

propagation loss PL=output Pt−transmission feed loss Lt+transmission antenna gain Gt+receiving antenna gain Gr−reception feed loss Lr−radio field intensity Pr (1)

The values on the right-hand side of Expression (1) are included in the measurement data received from the wireless communication device 40.

Then, the site survey unit 11 converts the point cloud data into 3D CAD data (step S13). The 3D CAD data indicates a shape of an object by a three-dimensional coordinate system. Step S11 to step S13 need not be performed in this order. Details of the above processing will be described later.

Next, the environment label selection unit 12 selects an environment label to be given to a propagation model on the basis of a set of the 3D CAD data having coordinate information and the propagation loss data (step S14). Specifically, the environment label selection unit 12 extracts a feature (e.g., structure density in a case where the communication use environment is a factory) from the 3D CAD data with reference to the past model and selects an environment label to be given by threshold determination. The environment label selection unit 12 may select the environment label to be given by using a classification-type machine learning device having an automatic identification function for identifying a propagation environment. Details of the above processing will be described later.

The propagation models may be considered as being different on a per environment label basis. In this case, selection of the environment label to be given can also be referred to as selection of the propagation model.

Next, the data processing unit 13 tunes a parameter of the propagation model by using the propagation loss data (step S15). Specifically, the data processing unit 13 updates parameters of both the ray tracing model 101 and the statistical model 102. By tuning the propagation models according to the communication use environment, it is possible to improve estimation accuracy of the radio field intensity. Details of the processing in step S15 will be described later.

Then, the radio field intensity estimation unit 14 receives input of a frequency band of an estimation system and calculates the propagation loss PL with respect to the distance (step S16). The estimation system is a system of the communication use environment for which estimation is performed. Specifically, the radio field intensity estimation unit 14 inputs the frequency band to the propagation model (the ray tracing model 101 or the statistical model 102) to which the environment label has been given and performs simulation, thereby calculating the propagation loss PL. Then, the radio field intensity estimation unit 14 calculates a radio field intensity Pr according to Expression (2) below on the basis of the calculated propagation loss PL (step S17).

radio field intensity Pr=output Pt−transmission feed loss Lt+transmission antenna gain Gt+receiving antenna gain Gr−reception feed loss Lr−propagation loss PL (2)

Next, details of the processing in each step described above will be described.

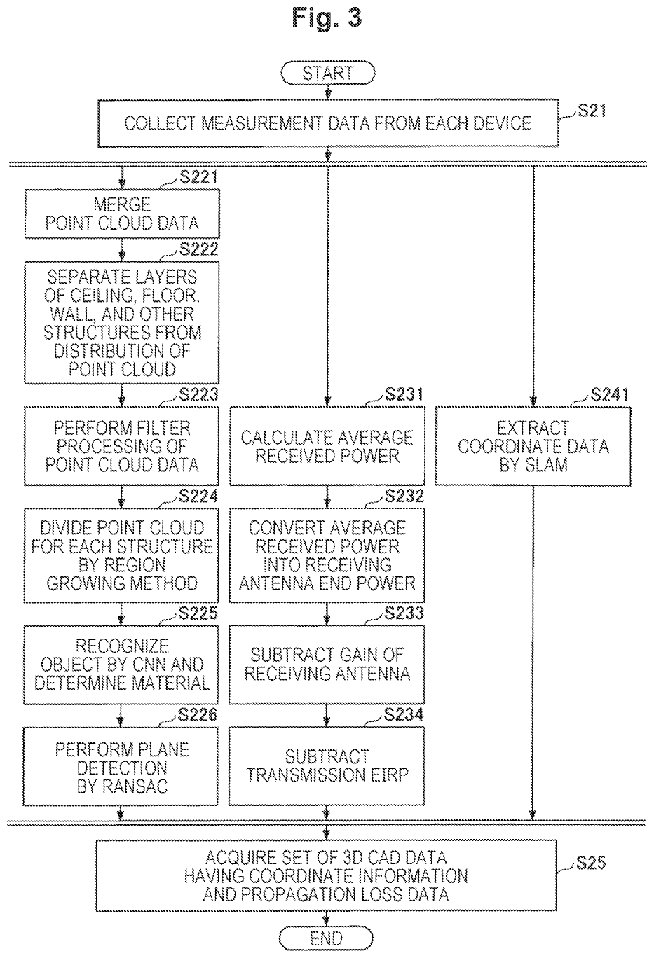

FIG. 3 is a flowchart showing an example of a flow of 3D CAD data generation processing. The 3D CAD data generation processing is details of step S11 to step S13 described above.

The site survey unit 11 collects measurement data from each device (step S21). Next, the site survey unit 11 executes the first to third processing flows in parallel. The site survey unit 11 may sequentially process all or part of the first to third processing flows in any order.

As the first processing flow, the site survey unit 11 merges the point cloud data (step S221). Specifically, in a case where the site survey unit 11 acquires point cloud data from a plurality of devices, the site survey unit translates and rotates coordinates from positions of three reference markers and merges the coordinates in order to match the respective coordinate systems. Next, the site survey unit 11 separates layers of a ceiling, floor, wall, and other structures from a distribution of the point cloud (step S222). This is because a distribution of amounts of acquisition of the point cloud data differ with respect to a surface area.

The site survey unit 11 performs filter processing on the point cloud data (step S223). Specifically, the site survey unit 11 performs filter processing by downsampling using “voxel grid filter” or the like. In a case where the collected measurement data is image data, the site survey unit 11 may perform modeling on the assumption that pixels of the image correspond to the point cloud. Next, the site survey unit 11 divides the point cloud for each structure by a region growing method (step S224).

Then, the site survey unit 11 recognizes an object by a convolutional neural network (CNN) and gives typical material information of the recognized object thereto (step S225). Then, the site survey unit 11 performs plane detection by random sample consensus (RANSAC) (step S234). In the processing in step S234, the site survey unit 11 may detect a plane and then subdivide the plane into surface elements by Delaunay triangulation. By the first processing flow, 3D CAD data indicating various structures including structures provided in a building, such as a ceiling, a floor, and a wall, and installed objects inside the building is generated.

As the second processing flow, the site survey unit 11 calculates average received power for each measurement point on the basis of the received measurement data such as the radio field intensity (step S231). Then, the site survey unit 11 converts the average received power into receiving antenna end power (step S232), subtracts a gain of the receiving antenna (step S233), subtracts transmission equivalent isotropic radiated power (EIRP) (step S234), and thus converts the receiving antenna end power into propagation loss data.

As the third processing flow, the site survey unit 11 extracts coordinate data by SLAM (step S241).

The site survey unit 11 integrates results of the first to third processing flows to acquire the set of the 3D CAD data having the coordinate information and the propagation loss data (step S25).

In propagation simulation used for conventional area design, a propagation characteristic is estimated by using CAD data of buildings, structures, and the like. However, in an indoor environment such as a factory, there is no data indicating a layout of a structure in some cases. In such a case, it is necessary to manually create CAD data of the environment.

In contrast, according to the communication design support apparatus 10 of the present embodiment, 3D CAD data is automatically generated on the basis of measurement data. Therefore, it is possible to design wireless communication, without relying on skill of the user.

Note that the site survey unit 11 may include: an acquisition unit that acquires point cloud data of a structure and measurement data of a radio field intensity; a structure data generation unit that performs object recognition and material determination of the point cloud data and generates structure data indicating a shape and material of the structure; a propagation loss calculation unit that calculates propagation loss on the basis of the measurement data of the radio field intensity in an environment including the structure; and an output unit that outputs data in which the structure data and propagation loss data are associated with each other.

The structure data indicating the shape and material of the structure includes information related to quality of wireless communication. Therefore, the structure data is suitable for propagation simulation of wireless communication.

The site survey unit 11 may further include an extraction unit that extracts coordinate data by SLAM.

Next, details of the processing in step S15 of the communication design support processing will be described. In step S15, the data processing unit 13 tunes the ray tracing model 101 or the statistical model 102.

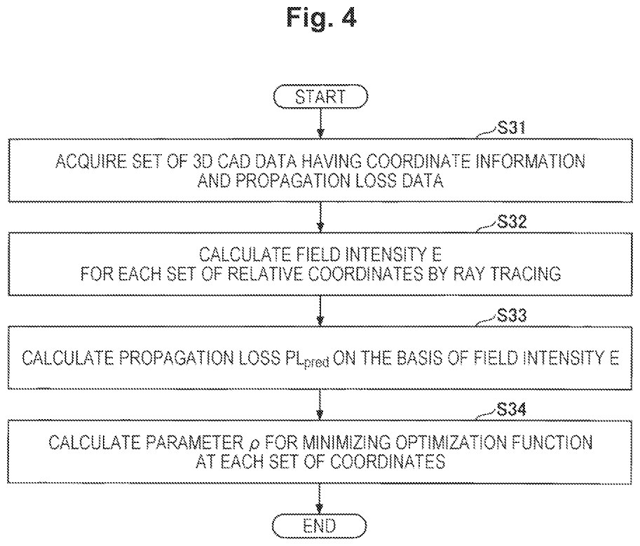

FIG. 4 is a flowchart showing an example of a flow of ray tracing model tuning processing.

The data processing unit 13 acquires the set of the 3D CAD data having the coordinate information and the propagation loss data acquired by the processing in step S26 of the above 3D CAD data generation processing (step S31). The propagation loss data is expressed as (X, Y, Z, PLmeas). In a case where a frequency band of a wireless standard with respect to which measurement is performed is different from a frequency band of a wireless standard with respect to which estimation is performed, frequency characteristics should be estimated by the data processing unit 13, and it is necessary to acquire propagation loss data PLmeas with respect to two or more different frequency bands.

The data processing unit 13 calculates a field intensity E for each set of relative coordinates by ray tracing on the basis of the following expression (step S32).

$$E = \frac{{e}^{- {jkS}_{1}}}{{S}_{1}} {\prod }_{j} ρ {R}_{j} ( θ , μ , ε , σ , ω ) {\prod }_{m} \sqrt{\frac{{S}_{l}}{( {S}_{m} + {S}_{m + 1} )}} {D}_{l} {e}^{- {jkS}_{m + 1}} {\prod }_{l} {T}_{l} \qquad [ Math . 1 ]$$

Here, a reflection coefficient R has a frequency characteristic, and the reflection coefficient varies depending on a relationship between the material, the shape of the structure, or the like and wavelength. The parameter ρ is a correction coefficient for correcting the frequency characteristic.

Next, the data processing unit 13 calculates propagation loss PLpred by using the field intensity E on the basis of the following expression (step S33).

$${PL}_{pred} = 20 {log}_{10} \frac{4 π f}{c} - 20 {log}_{10} \sqrt{{E}_{re}^{2} - {E}_{im}^{2}} \qquad [ Math . 2 ]$$

Then, the data processing unit 13 calculates the parameter ρ for minimizing an optimization function at each set of coordinates (step S34). The optimization function is, for example, Σ(PLmeas−PLpred)2. In a case where the frequency characteristic is estimated, propagation loss data PLmeas of two or more different frequency bands is used.

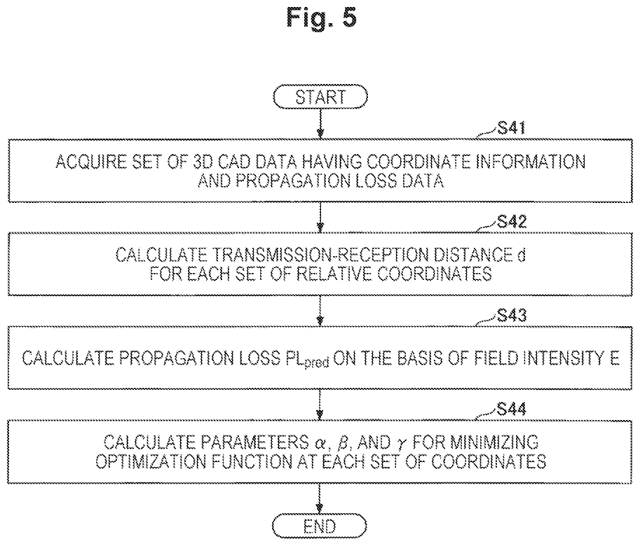

FIG. 5 is a flowchart showing an example of a flow of statistical model tuning processing.

The data processing unit 13 acquires the set of the 3D CAD data having the coordinate information and the propagation loss data acquired by the processing in step S26 of the above 3D CAD data generation processing (step S41). The propagation loss data is expressed as (X, Y, Z, PLmeas). In a case where a frequency band of a wireless standard with respect to which measurement is performed is different from a frequency band of a wireless standard with respect to which estimation is performed, frequency characteristics should be estimated by the data processing unit 13, and thus PLmeas is propagation loss data with respect to two or more different frequency bands.

Next, the data processing unit 13 calculates a transmission-reception distance d for each set of relative coordinates (step S42). Then, the data processing unit 13 calculates the propagation loss PLpred by using the field intensity E on the basis of the following expression (step S43).

PLpred=10α log 10d+γ+10β log 10f

Here, the parameter β has a frequency characteristic and is a correction coefficient for correcting the frequency characteristic.

Then, the data processing unit 13 calculates the parameters α, β, and γ for minimizing an optimization function at each set of coordinates (step S44). In a case where the frequency characteristic is estimated, PLmeas is propagation loss data with respect to two or more different frequency bands.

In estimation of the radio field intensity in the conventional area design, a typical value of each parameter is calculated and used on the basis of measurement data in various environments. Thus, there is a problem that a characteristic specific to a location cannot be evaluated. Further, because it is necessary to perform tuning for the measurement data with respect to the measured wireless standard, there is a problem that only the characteristic with respect to the frequency band of the wireless standard can be evaluated.

In contrast, the communication design support apparatus 10 according to the present embodiment optimizes a ray tracing parameter (equivalent reflection coefficient) or each coefficient of the statistical model by using the radio field intensity estimation accuracy as an index on the basis of a result of simulation performed on the premise of the set of the relative coordinates, the 3D CAD data, and the propagation loss data obtained by the site survey and the propagation loss data obtained in the use environment, and tunes the propagation model according to the use environment. Therefore, it is possible to evaluate location-specific characteristics of different frequency bands.

The data processing unit 13 may include: an acquisition unit that acquires data in which structure data containing coordinate data is associated with data indicating propagation loss; and a parameter update unit that updates a parameter of a propagation model on the basis of the acquired data. The parameter update unit can reflect a frequency characteristic by applying the propagation model to calculate a field intensity and updating the parameter to a parameter for minimizing the propagation loss based on the calculated field intensity.

Next, details of the processing in step S14 of the communication design support processing will be described. In step S14, the environment label selection unit 12 tunes the ray tracing model 101 or the statistical model 102.

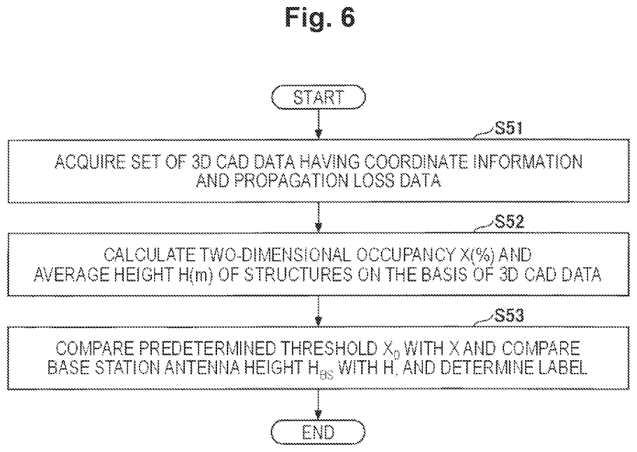

FIG. 6 is a flowchart showing an example of a flow of environment label selection processing based on threshold determination.

The environment label selection unit 12 acquires the set of the 3D CAD data having the coordinate information and the propagation loss data acquired by the processing in step S26 of the above 3D CAD data generation processing (step S51). Next, the environment label selection unit 12 calculates two-dimensional occupancy X (%) and an average height (m) of structures on the basis of the 3D CAD data (step S52). Next, the environment label selection unit 12 compares a predetermined threshold X0 with X, compares a base station antenna height HBS with H, and determines a label (step S53). Specifically, the label is determined as follows.
(1) a low-density and high-clutter model for X0>X and HBS<H
(2) a low-density and low-clutter model for X0>X and HBS>H
(3) a high-density and high-clutter model for X0<X and HBS<H
(4) a high-density and low-clutter model for X0<X and HBS>H

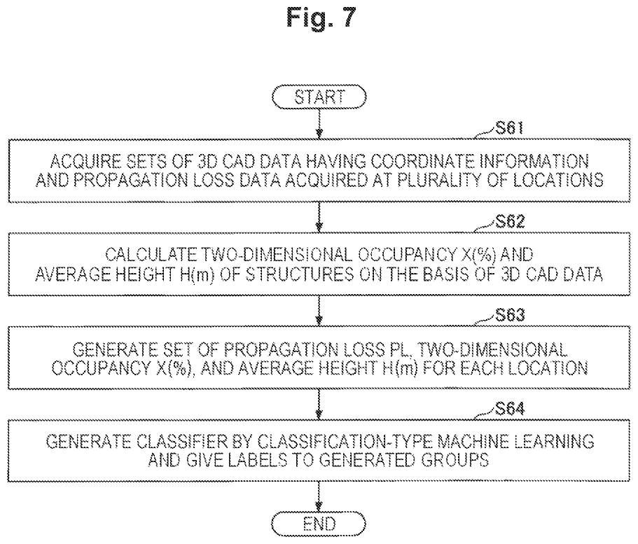

FIG. 7 is a flowchart showing an example of a flow of classifier training processing. The environment label selection unit 12 acquires sets of 3D CAD data having coordinate information and propagation loss data acquired at a plurality of locations (step S61). Next, the environment label selection unit 12 calculates two-dimensional occupancy X (%) and an average height (m) of structures on the basis of the 3D CAD data (step S62). Then, the environment label selection unit 12 generates a set of the propagation loss PL, the two-dimensional occupancy X (%), and the average height H (m) for each location (step S63). Then, the environment label selection unit 12 generates a classifier by classification-type machine learning and gives labels to generated groups (step S64). The method of machine learning may be of any classification-type learning device and, for example, a k-nearest neighbor algorithm, a support vector machine (SVM), or linear discriminant may be used for the machine learning.

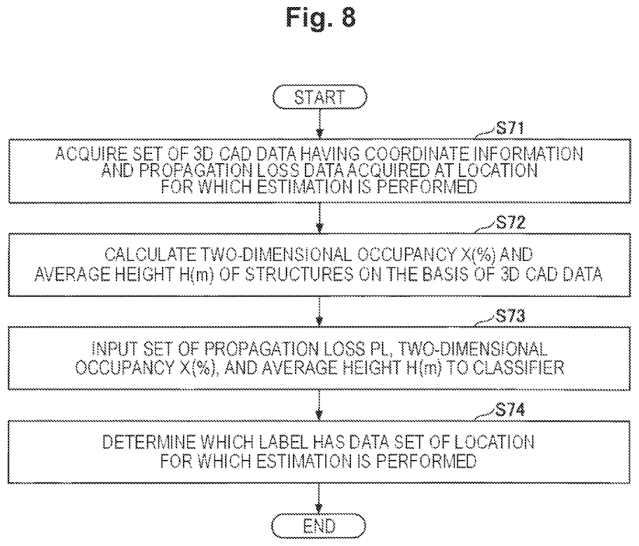

The environment label selection unit 12 selects an environment label by using the classifier trained in this manner. FIG. 8 is a flowchart showing an example of a flow of environment label selection processing based on determination by the classifier.

The environment label selection unit 12 acquires a set of 3D CAD data having coordinate information and propagation loss data acquired at a location for which estimation is performed (step S71). Next, the environment label selection unit 12 calculates two-dimensional occupancy X (%) and an average height (m) of structures on the basis of the 3D CAD data (step S72). Then, the environment label selection unit 12 inputs a set of the propagation loss PL, the two-dimensional occupancy X (%), and the average height H (m) to the classifier (step S73). Then, the environment label selection unit 12 determines which label has the data set of the location for which estimation is performed (step S74).

As the propagation characteristics, there are various propagation models such as multi-hop transmission and a two-ray model according to the use environment (e.g., location, antenna height, and frequency). In conventional actual use, the user needs to select an appropriate model from various models on the basis of a propagation measurement result. However, it takes time even for an expert to select a model, and thus, for ordinary people, it is difficult to determine a model in the first place.

The communication design support apparatus 10 according to the present embodiment determines an environment label according to the use environment and therefore can obtain the same effect as that of selecting a propagation model according to the use environment.

The environment label selection unit 12 may also include: an acquisition unit that acquires data in which structure data containing coordinate data is associated with data indicating propagation loss; and a selection unit that selects data indicating classification of a characteristic of a communication environment with respect to a structure indicated by the structure data on the basis of the acquired data.

The acquisition unit may further acquire information indicating an antenna height of a base station, and the selection unit may calculate occupancy of the structure and a statistical value of a height of the structure and select the data indicating the classification of the characteristic of the communication environment on the basis of a result of comparison between a predetermined threshold and the occupancy and a result of comparison between the antenna height and the statistical value.

The selection unit may also calculate occupancy of the structure and the statistical value of the height of the structure, input the calculated occupancy and statistical value to the classifier, and select the data indicating the classification of the characteristic of the communication environment.

The environment label selection unit 12 may further include a learning unit that trains the classifier by classification-type machine learning.

Next, details of the processing in step S16 of the communication design support processing will be described. In step S16, the radio field intensity estimation unit 14 calculates the propagation loss PL.

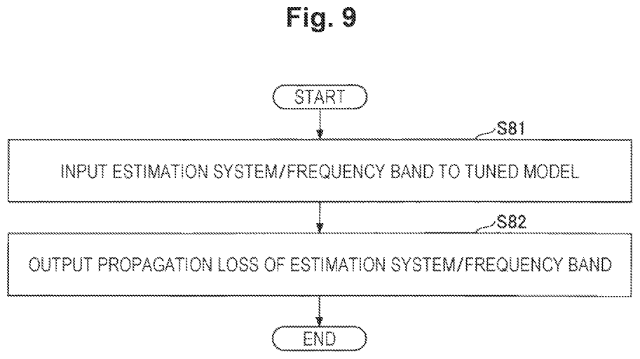

FIG. 9 is a flowchart showing an example of a flow of frequency correction processing.

The radio field intensity estimation unit 14 inputs the frequency band of the estimation system to the propagation model tuned by the data processing unit 13 (step S81). Then, the radio field intensity estimation unit acquires propagation loss output from the propagation model (step S82).

Conventionally, in a case where area evaluation of a new system is performed, there is a method of temporarily installing the new system to perform a site survey. However, there is a problem that it is difficult to perform a site survey with respect to a wireless standard that requires a license, and thus area evaluation based on a survey result cannot be performed in advance.

The communication design support apparatus 10 according to the present embodiment calibrates existing (e.g., a wireless standard that does not need a license) sensed channel data to obtain propagation loss and tunes (tuning by the data processing unit 13) a parameter having frequency dependence (e.g., a reflection coefficient with respect to ray tracing) with respect to ray tracing or the statistical model. Then, the communication design support apparatus inputs a new frequency (e.g., of a wireless standard that needs a license) to the tuned ray tracing model 101 or statistical model 102 and simulates the propagation loss, to estimate the radio field intensity.

The radio field intensity estimation unit 14 may include: an acquisition unit that acquires data in which structure data containing coordinate data is associated with data indicating propagation loss with respect to a plurality of frequency bands; an input receiving unit that receives input of a frequency band for which a radio field intensity is to be estimated; and an estimation unit that inputs the frequency band to a propagation model and estimates propagation loss.

When estimating the radio field intensity on the basis of a ray tracing model, the radio field intensity estimation unit 14 may determine a two-dimensional ray trace from a transmission point to a reception point of a radio wave and determine a three-dimensional ray trace corresponding to the two-dimensional ray trace by using height information of the transmission point and the reception point in order to speed up estimation processing. This makes it possible to search for a main ray and also to speed up the processing while preventing degradation in accuracy, as compared with determining a three-dimensional ray trace from the beginning.

When estimating the radio field intensity on the basis of the ray tracing model, the radio field intensity estimation unit 14 may convert data indicating a width, height, shape, position, and the like of each surface of an object (e.g., structure or building) in a target area into two-dimensional mesh data. The mesh data has a format of image data and, thus it is possible to perform reading and processing at high speed by using a graphics processing unit (GPU).

The communication design support apparatus 10 may include: a propagation model storage unit that stores a propagation model; an acquisition unit that acquires point cloud data of a structure and measurement data of radio wave intensities with respect to a plurality of frequency bands; a parameter update unit that updates a parameter of the propagation model on the basis of the acquired data; and an estimation unit that estimates propagation loss on the basis of the propagation model. This makes it possible to achieve communication design that does not rely on the skill of the user.

### (Hardware Configuration Example)

The communication design support apparatus 10 according to the present embodiment can be achieved by, for example, causing a computer to execute a program in which content of the processing described in the present embodiment is written.

The above program can be recorded in a computer-readable recording medium (e.g., portable memory) to be stored or distributed. Further, the above program can also be provided via a network such as the Internet or e-mail.

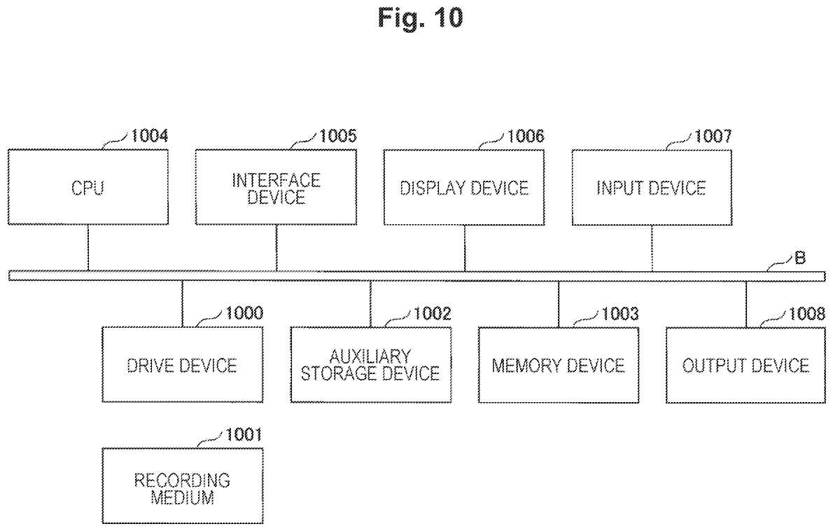

FIG. 10 illustrates a hardware configuration example of the computer. The computer in FIG. 10 includes, for example, a drive device 1000, an auxiliary storage device 1002, a memory device 1003, a CPU 1004, an interface device 1005, a display device 1006, an input device 1007, and an output device 1008 that are connected to one another by a bus B.

The program for implementing processing in the computer is provided by, for example, a recording medium 1001 such as a CD-ROM or memory card. When the recording medium 1001 storing the program is set in the drive device 1000, the program is installed from the recording medium 1001 into the auxiliary storage device 1002 via the drive device 1000. However, the program is not necessarily installed from the recording medium 1001 and may be downloaded from another computer via a network. The auxiliary storage device 1002 stores the installed program and also stores necessary files, data, and the like.

In a case where an instruction to start the program is given, the memory device 1003 reads the program from the auxiliary storage device 1002 and stores the program therein. The CPU 1004 implements a function of each unit described in the present embodiment in accordance with the program stored in the memory device 1003. The interface device 1005 is used as an interface for connecting to a network. The display device 1006 displays a GUI or the like by the program. The input device 1007 includes, for example, a keyboard, a mouse, buttons, and a touchscreen and is used to input various operation instructions. The output device 1008 outputs a calculation result. In the communication design support apparatus 10, either or both of the display device 1006 and the input device 1007 need not be provided.

Hereinafter, the first to sixth examples will be described as specific examples of the technology according to the present embodiment. Any of the first to sixth examples may be appropriately combined and implemented.

### First Example

In the first example, for the purpose of automating local survey work, a local staff takes photographs by using a tablet terminal such as a smartphone, acquires Lidar, and measures a radio field intensity with respect to a wireless standard for which the measurement is performed while moving in the location. The communication design support apparatus 10 creates and displays 3D CAD data on the basis of the measurement result.

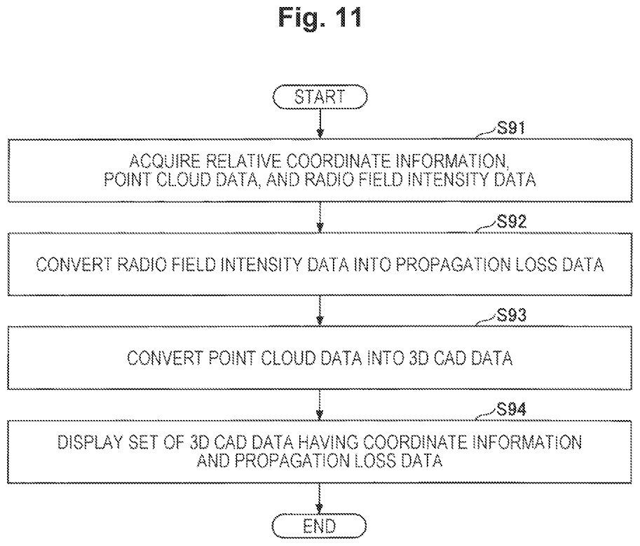

FIG. 11 is a flowchart showing an example of a flow of communication design support processing according to the first example.

A user such as a local staff inputs account information and information indicating a wireless standard. For example, the user inputs account information and inputs information such as 2.4 GHz WLAN, 5 GHz WLAN, or 60 GHz WiGig as a wireless standard for which the measurement is performed. The site survey unit 11 acquires relative coordinate information, point cloud data, and radio field intensity data on the basis of the input information (step S91). The point cloud data, the radio field intensity, and the coordinates are acquired by different modules and thus are matched by using a timestamp. Then, the site survey unit 11 refers to a conversion table between received power and receiving antenna end power of a measurement device, transmission EIRP information, and the like on the basis of the wireless standard information and converts the radio field intensity data into propagation loss data (step S92). Next, the site survey unit 11 converts the point cloud data into 3D CAD data (step S93).

Next, the site survey unit 11 displays a set of the 3D CAD data having coordinate information and the propagation loss data (step S94).

The local staff or a sales/SE staff may refer to the created set of the 3D CAD data and the propagation loss data or may call and use the set for designing.

### Second Example

The second example shows an example where a local staff simply estimates propagation quality of a wireless standard different from a wireless standard with respect to which measurement is performed on the basis of a measurement result of the wireless standard with respect to which measurement is performed and uses the estimated propagation quality for estimating a facility scale or the like.

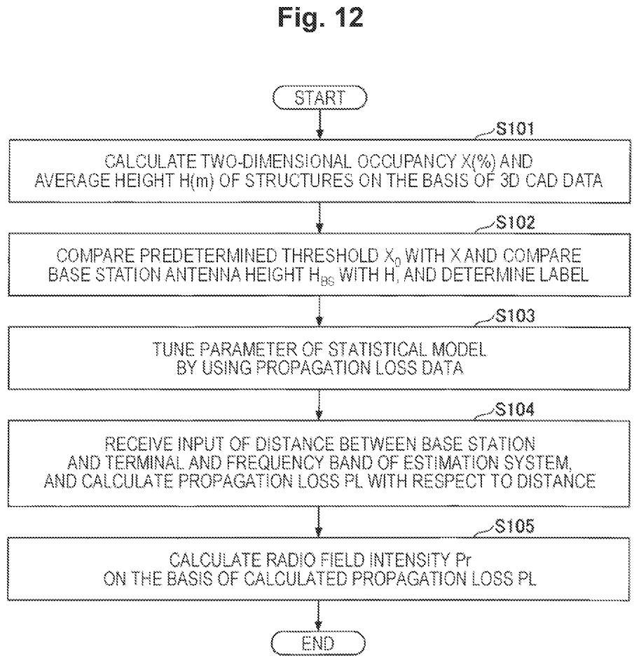

FIG. 12 is a flowchart showing an example of a flow of communication design support processing according to the second example.

A user such as a local staff inputs an estimated base station position, a terminal station design condition (e.g., position information), wireless standards used for measurement and estimation, and account information. For example, the user inputs account information, inputs information such as 2.4 GHz WLAN, 5 GHz WLAN, or 60 GHz WiGig as the wireless standard with respect to which measurement is performed, and inputs information such as 4.8 GHz L5G or 28 GHz L5G as the wireless standard with respect to which estimation is performed.

The environment label selection unit 12 calculates two-dimensional occupancy X (%) and an average height (m) of structures on the basis of the 3D CAD data (step S101). Next, the environment label selection unit 12 compares the predetermined threshold X0 with X and compares the base station antenna heights HBS with H and determines a label (step S102). With respect to the radio field intensity estimation unit 14, the statistical model and the ray tracing model are greatly different from each other in calculation time thereof and a feature of propagation quality information that is output. In the ray tracing model, propagation loss can be estimated for each location, whereas only a change in the propagation loss with respect to a distance can be estimated in the statistical model. However, the ray tracing model requires a longer calculation time than the statistical model. Therefore, the statistical model is used to simply estimate a facility scale or the like in the location. The data processing unit 13 tunes a parameter of the statistical model by using the propagation loss data (step S103). Then, the radio field intensity estimation unit 14 receives input of a distance between the base station and the terminal and a frequency band of an estimation system and calculates the propagation loss PL with respect to the distance (step S104). The radio field intensity estimation unit 14 calculates the radio field intensity Pr on the basis of the calculated propagation loss PL (step S105).

Note that the local staff or sales/SE staff can perform design, estimation, or the like on the basis of the estimated radio field intensity Pr.

### Third Example

The third example shows an example where a wireless facility operational design staff estimates propagation quality of a wireless standard different from a wireless standard with respect to which measurement is performed for each designated terminal station position on the basis of a measurement result of the wireless standard with respect to which measurement is performed and designs a radio parameter.

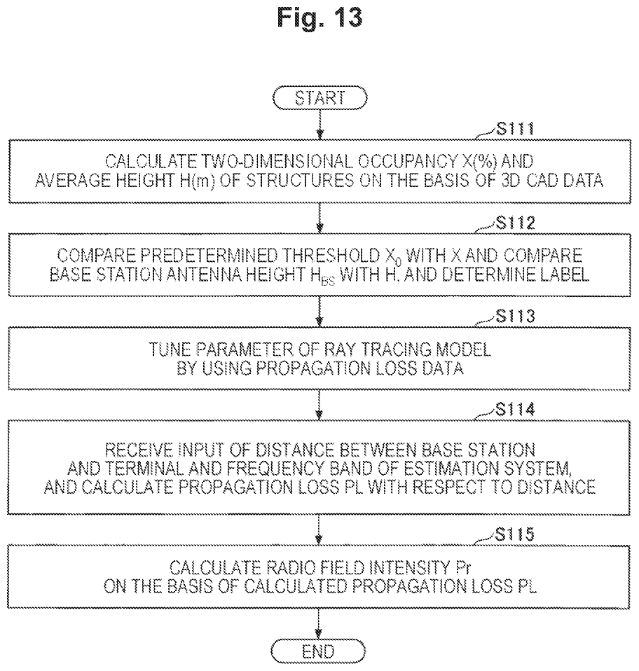

FIG. 13 is a flowchart showing an example of a flow of communication design support processing according to the third example.

A user such as a local staff inputs an estimated base station, a terminal station design condition (e.g., position information), wireless standards used for measurement and estimation, and account information. For example, the user inputs account information, inputs information such as 2.4 GHz WLAN, 5 GHz WLAN, or 60 GHz WiGig as the wireless standard with respect to which measurement is performed, and inputs information such as 4.8 GHz L5G or 28 GHz L5G as the wireless standard with respect to which estimation is performed.

The environment label selection unit 12 calculates two-dimensional occupancy X (%) and an average height (m) of structures on the basis of 3D CAD data (step S111). Next, the environment label selection unit 12 compares the predetermined threshold X0 with X and compares the base station antenna height HBS with H and determines a label (step S112). The radio field intensity estimation unit 14 uses a ray tracing model capable of performing estimation for each terminal station position, and thus the data processing unit 13 tunes a parameter of the ray tracing model by using propagation loss data (step S113). Then, the radio field intensity estimation unit 14 receives input of a distance between the base station and the terminal and a frequency band of an estimation system and calculates the propagation loss PL with respect to the distance (step S114). The radio field intensity estimation unit 14 calculates the radio field intensity Pr on the basis of the calculated propagation loss PL (step S115).

The wireless facility operational design staff can design, for example, radio parameters based on the estimated radio field intensity Pr.

### Fourth Example

The fourth example shows an example where a local staff or sales/SE staff determines whether to change a system in advance in a wireless standard operation phase in an indoor local area.

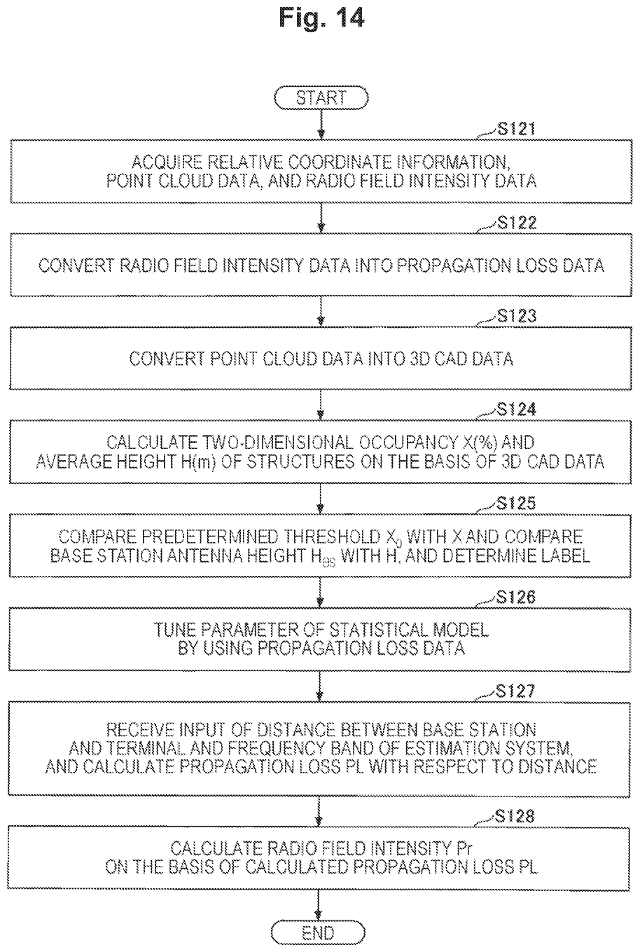

FIG. 14 is a flowchart showing an example of a flow of communication design support processing according to the fourth example.

The site survey unit 11 acquires relative coordinate information, point cloud data, and radio field intensity data (step S121). Next, the site survey unit 11 converts the radio field intensity data into propagation loss data (step S122). Then, the site survey unit 11 converts the point cloud data into 3D CAD data (step S123). Next, the environment label selection unit 12 calculates two-dimensional occupancy X (%) and an average height (m) of structures on the basis of the 3D CAD data (step S124). The environment label selection unit 12 compares the predetermined threshold X0 with X and compares the base station antenna height HBS with H and determines a label (step S125).

The radio field intensity estimation unit 14 uses a statistical model whose calculation time is short, and thus the data processing unit 13 tunes a parameter of the statistical model by using the propagation loss data (step S126). Then, the radio field intensity estimation unit 14 receives input of a distance between the base station and the terminal and a frequency band of an estimation system and calculates the propagation loss PL with respect to the distance (step S127). The radio field intensity estimation unit 14 calculates the radio field intensity Pr on the basis of the calculated propagation loss PL (step S128).

Note that, instead of the above processing from step S121 to step S123, the communication design support apparatus 10 may use the 3D CAD data of the corresponding area manually edited by the user. The site survey unit 11 may have a function of receiving editing of the 3D CAD data by the user.

The local staff or sales/SE staff can determine whether to change design of a wireless standard currently in operation on the basis of the estimated radio field intensity Pr.

### Fifth Example

The fifth example shows an example of estimating propagation quality of a new wireless standard when an indoor local area (e.g., factory) is newly set.

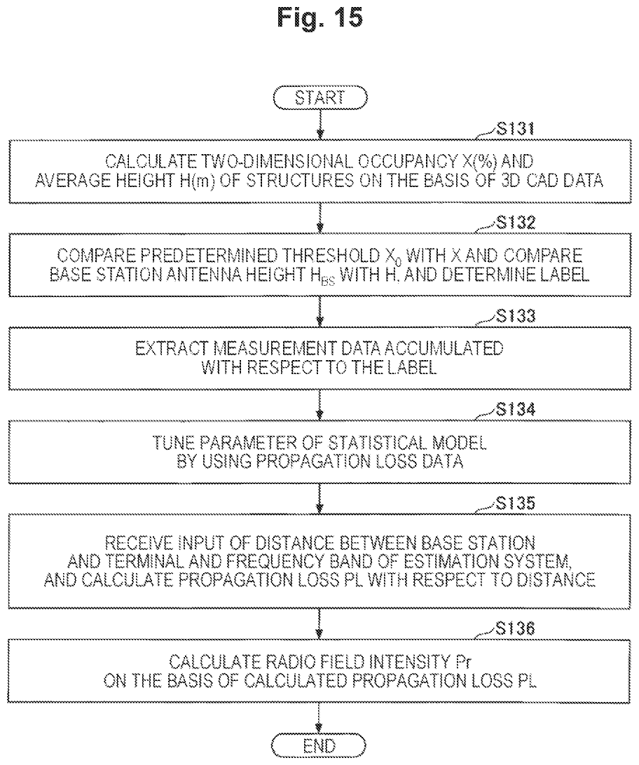

FIG. 15 is a flowchart showing an example of a flow of communication design support processing according to the fifth example.

A user such as a local staff or sales/SE staff creates 3D CAD data on the basis of layout data of a new environment and starts the environment label selection unit 12.

The environment label selection unit 12 calculates two-dimensional occupancy X (%) and an average height (m) of structures on the basis of the 3D CAD data (step S131). The environment label selection unit 12 compares the predetermined threshold X0 with X and compares the base station antenna height HBS with H and determines a label (step S132).

Then, in response a user operation, the data processing unit 13 extracts measurement data accumulated with respect to the label (step S133). The radio field intensity estimation unit 14 uses a statistical model whose calculation time is short, and thus the data processing unit 13 tunes a parameter of the statistical model by using propagation loss data (step S134). Then, the radio field intensity estimation unit 14 receives input of a distance between the base station and the terminal and a frequency band of an estimation system and calculates the propagation loss PL with respect to the distance (step S135). The radio field intensity estimation unit 14 calculates the radio field intensity Pr on the basis of the calculated propagation loss PL (step S136).

The local staff or sales/SE staff can estimate propagation quality of a new wireless standard on the basis of the estimated radio field intensity Pr and use the propagation quality for estimation, sales, design, or the like.

### Sixth Example

The sixth example shows an example where, in a case where there is no layout data and measurement with respect to a wireless standard cannot be performed when an indoor local area (e.g., factory) is newly set, propagation quality with respect to the wireless standard is estimated and is used for estimation of a facility scale or the like.

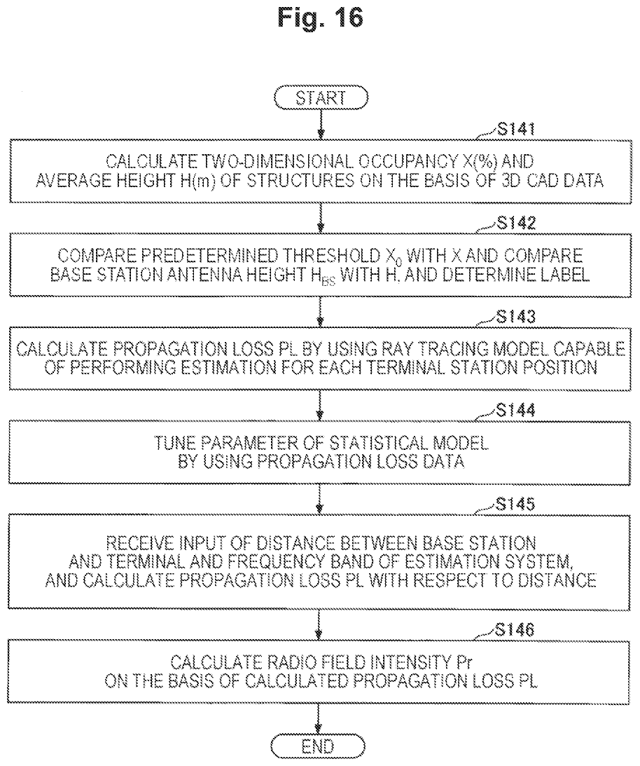

FIG. 16 is a flowchart showing an example of a flow of communication design support processing according to the sixth example.

The local staff or sales/SE staff manually creates a typical indoor local area environment as 3D CAD data and starts the environment label selection unit 12.

The environment label selection unit 12 calculates two-dimensional occupancy X (%) and an average height (m) of structures on the basis of the 3D CAD data (step S141). The environment label selection unit 12 compares the predetermined threshold X0 with X and compares the base station antenna height HBS with H and determines a label (step S142). Next, the radio field intensity estimation unit 14 calculates the propagation loss PL by using a ray tracing model capable of performing estimation for each terminal station position (step S143).

Then, the data processing unit 13 tunes a parameter of the statistical model by using the calculated propagation loss data (step S144). Next, the radio field intensity estimation unit 14 receives input of a distance between the base station and the terminal and a frequency band of an estimation system and calculates the propagation loss PL with respect to the distance (step S145). The radio field intensity estimation unit 14 calculates the radio field intensity Pr on the basis of the calculated propagation loss PL (step S146).

In a case where there is no layout data and measurement with respect to a wireless standard cannot be performed when an indoor local area (e.g. factory) is newly set, the local staff or sales/SE staff can estimate the propagation quality of the wireless standard and estimate the facility scale or the like.

### Effects of Embodiment

According to the technology of the present embodiment, it is possible to support design of wireless communication according to various users' usage purposes, as in the first to sixth examples. Note that each functional unit (the site survey unit 11, the environment label selection unit 12, the data processing unit 13, and the radio field intensity estimation unit 14) of the communication design support apparatus 10 performs a function appropriately selected in accordance with a user operation as described in the first to sixth examples.

### Summary of Embodiment

The present specification discloses at least a communication design support apparatus, a communication design support method, and a program in accordance with the following items.

### (Item 1)

A communication design support apparatus including:

a propagation model storage unit configured to store a propagation model;

a site survey unit configured to collect data obtained by measuring a structure;

a data processing unit configured to update a parameter of the propagation model; and

a radio field intensity estimation unit configured to estimate a radio field intensity in the structure by applying the propagation model having the parameter having been updated.

### (Item 2)

The communication design support apparatus according to item 1, in which

the site survey unit is configure to receive input of information indicating an estimated base station position, an estimation system, and a use environment, and

the radio field intensity estimation unit is configured to estimate the radio field intensity in the structure on the basis of the input information having been input.

### (Item 3)

The communication design support apparatus according to item 1, in which

the site survey unit is configured to acquire relative coordinate information, point cloud data, and radio field intensity data, and

the radio field intensity estimation unit is configured to estimate the radio field intensity in the structure on the basis of the data having been acquired.

### (Item 4)

The communication design support apparatus according to item 3, further including

an environment label selection unit configured to receive input of data indicating a shape of a structure in a new environment and select data indicating classification of a characteristic of a communication environment in the structure on the basis of the data having been input, in which

the radio field intensity estimation unit is configured to estimate the radio field intensity in the structure by applying the propagation model according to the characteristic of the communication environment having been selected.

### (Item 5)

The communication design support apparatus according to item 4, in which

the communication design support apparatus is configured to perform a function selected in accordance with a user operation from among functions of the site survey unit, the environment label selection unit, the data processing unit, and the radio field intensity estimation unit.

### (Item 6)

A communication design support method performed by a computer storing a propagation model, the method including:

collecting data obtained by measuring a structure;

updating a parameter of the propagation model; and

estimating a radio field intensity in the structure by applying the propagation model having the parameter having been updated.

### (Item 7)

A program for causing a computer to function as the communication design support apparatus of any one of items 1 to 5.

The present embodiment has been described above, but the present invention is not limited to such a specific embodiment, and various modifications and changes can be made within the scope of the present invention described in the claims.

### Reference Signs List

1 Communication design support system
10 Communication design support apparatus
11 Site survey unit
12 Environment label selection unit
13 Data processing unit
14 Radio field intensity estimation unit
15 Propagation model storage unit
20 Imaging device
30 Distance measuring device
40 Wireless communication device
101 Ray tracing model
102 Statistical model
1000 Drive device
1001 Recording medium
1002 Auxiliary storage device
1003 Memory device
1004 CPU
1005 Interface device
1006 Display device
1007 Input device
1008 Output device

1. A communication design support apparatus comprising:
a memory configured to store a propagation model; and
a processor configured to:
collect data obtained by measuring a structure,
update a parameter of the propagation model, and
estimate a radio field intensity in the structure by applying the propagation model having the parameter having been updated.

2. The communication design support apparatus according to claim 1, wherein
the processor is configured to:
receive input of information indicating an estimated base station position, an estimation system, and a use environment, and
estimate the radio field intensity in the structure on the basis of the information having been input.

3. The communication design support apparatus according to claim 1, wherein
the processor is configured to:
acquire relative coordinate information, point cloud data, and radio field intensity data, and
estimate the radio field intensity in the structure on the basis of acquired data.

4. The communication design support apparatus according to claim 3, wherein
the processor is configured to:
receive input of data indicating a shape of a structure in a new environment and select data indicating classification of a characteristic of a communication environment in the structure on the basis of the data having been input, and
estimate the radio field intensity in the structure by applying the propagation model according to the characteristic of the communication environment having been selected.

5. The communication design support apparatus according to claim 4, wherein
the processor is configured to perform a function selected in accordance with a user operation from among:
collecting data obtained by measuring a structure, or receiving input of information indicating an estimated base station position, an estimation system, and a use environment, or acquiring relative coordinate information, point cloud data, and radio field intensity data;
receiving input of data indicating a shape of a structure in a new environment and selecting data indicating classification of a characteristic of a communication environment in the structure on the basis of the data having been input;
updating a parameter of the propagation model; and
estimating a radio field intensity in the structure by applying the propagation model having the parameter having been updated, or estimating the radio field intensity in the structure on the basis of the information having been input, or estimating the radio field intensity in the structure on the basis of acquired data, or estimating the radio field intensity in the structure by applying the propagation model according to the characteristic of the communication environment having been selected.

6. A communication design support method performed by a computer storing a propagation model, the method comprising:
collecting data obtained by measuring a structure;
updating a parameter of the propagation model; and
estimating a radio field intensity in the structure by applying the propagation model having the parameter having been updated.

7. A non-transitory computer-readable recording medium storing a propagation model and a program for causing a computer to:
collect data obtained by measuring a structure,
update a parameter of the propagation model, and
estimate a radio field intensity in the structure by applying the propagation model having the parameter having been updated.
